(19) United States
(12) Patent Application Publication
(10) Pub. No.: US 2014/0141239 A1
(43) Pub. Date: May 22, 2014

(54) Same-Day use floor coating and methods

(71) Applicant: Patrick Ilfrey, Onalaska, WI (US)

(72) Inventor: Patrick Ilfrey, Onalaska, WI (US)

(21) Appl. No.: 13/694,326

(22) Filed: Nov. 19, 2012

(51) Int. Cl. B05D 5/00; B32B 15/08; B32B 27/28; B32B 27/06; B32B 27/14

(52) U.S. Cl. CPC B05D 5/00; B32B 27/06; B32B 27/14; B32B 27/28; B32B 15/08
USPC 428/339; 524/590; 428/500; 428/461; 428/537.1; 427/202; 427/136

(57) ABSTRACT

Provided herein are multi-layered structures comprising coated substrates, and methods for producing the layered structures provided. Coatings according to the disclosure are provided in greatly reduced time frames as compared to coatings of the prior art. Coating structures as provided herein can be applied to a substrate such as a garage floor, a truck bed, railcar, seatainer, tractor-trailers and the like within a single day, and are sufficiently cured to withstand heavy traffic such as motorized vehicle traffic in as little as two hours after application of the polymer precursor layer material employed.

### CROSS-REFERENCES TO RELATED APPLICATIONS

This application is a continuation of U.S. patent application Ser. No. 12/001,372 filed Dec. 11, 2007, currently still pending, the entire contents of which are herein fully incorporated by reference.

### TECHNICAL FIELD

This disclosure relates generally to coatings for various substrates, which coatings comprise a cured polymeric coating material formed from a flowable polymer precursor material and a layer of broadcast material disposed atop a substrate. More particularly it relates to coated structures disposed in architectural applications, such as floors and walls, and to coatings useful in connection with heaving equipment such as the interior and exterior of railcars, containers, tractor-trailers and truckbeds.

### BACKGROUND

Polymeric coatings are often employed to protect substrates such as floors, including concrete floors, from damage due to abrasions, and spills, and also to impart increased surface texture to provide the floors with skid resistance. Typically, the substrate is first prepared by various cleaning steps prior to application of liquid substances from which polymeric coatings are provided, after curing of the liquid substances. It is often desirable by workers in the art to apply a plurality of coatings over one another on such substrates. Since durable polymeric coatings often require relatively long cure times, it is typical for the entire operation of coating a substrate, such as a floor, to require more than one day's time prior to use of the floor or other substrate. This requirement using methods and coating schemes of the prior art is an inconvenience, inasmuch as it causes the area of the substrate that is desired to be coated to be effectively out of service for the amount of time that the entire substrate preparation, coating step(s), and final curing time occurs. In the vast majority of cases, this time period often exceeds two days, or more. The present disclosure provides various processes affording durable coatings on substrates which are completed within a single day.

### SUMMARY OF THE INVENTION

The present disclosure provides processes for providing a multi-layered structure which in some embodiments comprise the steps of: a) providing a substrate; b) preparing (cleaning) the substrate; c) applying a layer of flowable substance to the substrate, the layer of flowable substance comprising one or more than one precursor(s) from which a polymer selected from the group consisting of: epoxy polymer coatings, polyurea polymer coatings, and polyurethane polymer coatings is formed upon cure; and d) broadcasting or otherwise applying a layer of particulate material comprising a plurality of solid particles atop the layer of flowable substance prior to its cure, to provide a coated substrate capable of withstanding foot traffic after a time of six hours after initial application of the layer of flowable substance. The layer of material comprising a plurality of solid particles is referred to as a broadcast material by virtue of its being broadcasted over the first layer of polymeric precursor material prior to its cure.

In alternate embodiments, a method according to the disclosure includes the foregoing steps and a subsequent step of: e) applying a second flowable substance comprising one or more than one precursor(s) from which a polymer selected from the group consisting of: epoxy polymer coatings, polyurea polymer coatings, and polyurethane polymer coatings is formed upon curing, atop the layer of particulate material in step d) above.

### DETAILED DESCRIPTION

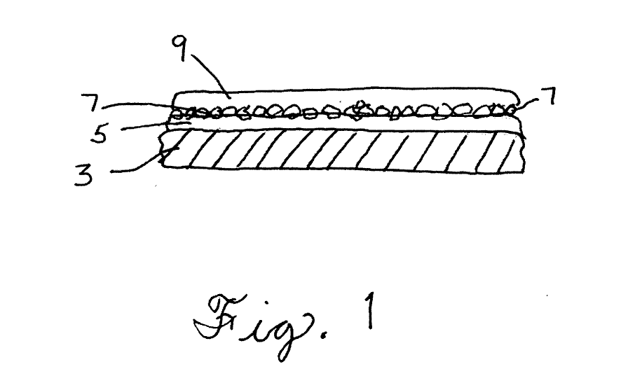

Referring to the drawing sheet FIG. 1 there is shown a cross-sectional view of a layered structure featuring a multi-layered coating provided on a substrate according to embodiments of this disclosure. In some embodiments, a completed layered structure as shown in FIG. 1 is provided at the passage of 24 hours from the time of the application of first layer 5. In other embodiments, a completed layered structure as shown in FIG. 1 is provided at the passage of 18 hours from the time of the application of first layer 5. In other embodiments, a completed layered structure as shown in FIG. 1 is provided at the passage of 12 hours from the time of the application of first layer 5. In other embodiments, a completed layered structure as shown in FIG. 1 is provided at the passage of about 6 hours from the time of the application of first layer 5. In other embodiments, a completed layered structure as shown in FIG. 1 is provided at the passage of 4 hours from the time of the application of first layer 5. In other embodiments, a completed layered structure as shown in FIG. 1 is provided at the passage of 3 hours from the time of the application of first layer 5. In some embodiments a layered structure such as that shown in FIG. 1 is considered to be completed when the polymeric precursor material(s) from which it is formed have cured sufficiently that the layered structure is capable of being walked upon by normal pedestrian traffic without the structure undergoing any detrimental change to its integrity. In other embodiments a layered structure such as that shown in FIG. 1 is considered to be completed when the polymeric precursor material(s) from which it is formed have cured sufficiently that the layered structure is capable of being driven on by a motorized vehicle without the structure undergoing any detrimental change to its integrity. Detrimental change is deformation of, or change in the profile of the polymeric layer as a result of its being subject to forces at a time when it has not adequately cured sufficiently to preclude such deformation or change under the force applied, such deformation being sufficient to cause decreased thickness of at least a portion of the underlying substrate layer 3 as evidenced by a visually-apparent permanent variation in thickness or distribution of first layer 5 that was not present therein immediately after the time that broadcast layer 7 or optional third layer 9 when selected to be present, was applied. Thus the cure time of the liquid flowable polymer precursor material from which first layer 5 and optional third layer 9 are formed is important, the cure time being that amount of time at which a polymer layer previously applied undergoes no detrimental change when subjected to pedestrian or motorized vehicle traffic mentioned herein. Fast-cure compositions are known in the art but were not employed in coating substrates as in the present disclosure owing to issues with workability of the material, and inferior adhesion of first layer 5 to the substrate due to the fast setting nature of prior art coating compositions.

The amount of time required for providing a completed multi-layered coated substrate as shown in FIG. 1 is dependent on the desired final structure, the materials selected for application to the substrate, the ambient conditions including temperature and humidity, and the amount of coverage of application in terms of mass of coating material applied per unit (square feet) of area, of the various layer(s) employed. In general, thinner layers allow for faster cure times but at the expense of durability of the layer formed. In a coated substrate according to this disclosure, cure times of any time between two hours and 24 hours are achievable. These cure times are defined by the ability to drive a motorized vehicle, as herein defined, atop a coated substrate according to this disclosure at the passage of any selected time period within the range of between two hours and 24 hours, without any of the coating material detaches from the substrate and sticks to the vehicle's tires at such a time selected.

In FIG. 1 there is shown a substrate 3, a first layer 5, a layer of broadcast material 7, and an optional third layer 9. The substrate 3 in some embodiments is a horizontal surface, which can include without limitation such surfaces as: interior flooring, exterior flooring such as concrete floors as commonly found on driveways, garage floors, parking lot surfaces, warehouse floors, floors in manufacturing facilities, restroom floors, animal kennel floors, restaurant floors, floors in medical facilities, laboratory floors, floor areas in retail establishments, basement floors, patio floors, automotive sales and service area floors, residential and commercial dwelling floors, and road surfaces. The substrate 3 may also comprise a non-horizontal surface, including those found on steps, walls, poles, columns, container interiors, railcars, truckbeds, tractor-trailers, utility trailers, animal trailers, and essentially any solid surface. Although some surfaces of the foregoing substrates are in some embodiments comprised of concrete, other materials including asphalt mixtures, “blacktop”, wood, metals, painted surfaces, and structural composites are also viable candidates as a substrate 3 over which various layers according to this disclosure can be disposed to provide a coated substrate according to this disclosure.

It is generally desirable to prepare the substrate 3 prior to application of the first layer 5, in order to promote adhesion between the first layer 5 and the substrate 3. Various means of substrate preparation are known in the art, including acid-etching in the case where the substrate 3 is concrete. Various acids are suitable for this purpose, including aqueous solutions which comprise one or more acids selected from the group consisting of: hydrochloric acid; hydrobromic acid; hydiodic acid; phosphoric acid; phosphorous acid; sulfuric acid; and nitric acid. Preferably, the total concentration of acid present in an aqueous solution to prepare a concrete surface prior to application of a first layer 5 according to the present disclosure is any amount between about 2% and 15% by weight based on the total weight of the acid solution. An acid pre-wash step of the substrate to be coated herein is indicated as being an option for every embodiment taught or described in this specification and the claims appended hereto for surfaces not detrimentally affected by acid treatment. In some embodiments, this contrasts with methods of the prior art which precluded a worker from applying a polyurea polymeric coating precursor to a substrate following an acid-wash step of the concrete, due to poor adhesion between the polyurea and the substrate that resulted due to the moisture that was introduced into the concrete during the washing process. Thus, according to prior art methods, concrete generally needs to dry thoroughly at least overnight, thus precluding the short installation times of multi-layered coated structures as provided herein. One product suitable to clean concrete prior to application of a first layer 5 when providing a coated substrate according to this disclosure is SafeEtch™ product available from Citadel Floor Finishing Systems of 3001 103^{rd} Lane Northeast, Blaine, Minn. 55449 (“Citadel”).

In some cases, concrete floors have a “hardener” or other protective coating over them, which is desirably removed when proceeding according to some embodiments of this disclosure prior to applying a first layer 5. Floor grinding machines comprising rotating or vibrating metallic discs having a layer of diamond particles adhered thereto are commonly used on floor surfaces to remove the top layer of material and to profile the surface prior to coating with a first layer 5. The types of metal-bonded diamonds used on different concretes commonly employed can include: hard bonded diamond, which is used for soft, open, and porous concrete; medium bond diamond, used for general purpose and broom finished concrete; and soft bond diamond, used for very hard, steel trowel, and/or burnished slabs.

A multi-layer structure as described herein is provided generally by applying a first layer 5 of material over the substrate 3, and subsequently broadcasting a layer of broadcast material 7 over the first layer prior to the substantial cure of the first layer 5. Materials for many of the various layers are viscous liquids which are accordingly flowable substances, which are in some embodiments applied manually, using any such common tools in the art including without limitation: a brush, a flat roller, a napped roller, or equipment that enables the flowable substance to be sprayed onto the substrate 3 using conventional spray equipment and optionally such equipment as described in my now-abandoned U.S. patent application Ser. No. 11/656,112 filed Jan. 22, 2007, the entire contents of which are herein incorporated by reference thereto.

The first layer 5 in some embodiments comprises an epoxy coating, which is provided by coating the substrate 3 with a flowable composition containing an epoxy dispersion or a reactive mixture of epoxy polymer precursors. Some aqueous-based epoxy dispersions are two-component mixtures, comprising a first component and a second component, the two components each being maintained separate from one another before their use and mixed prior to application, the first component comprising an epoxy resin and the second component comprising a curing agent and water, as is known in the art. In the case of such epoxy coating compositions, one component of the two part mixture from which the curable blend is formed is any material or mixture of two or more materials which contain at least two epoxy groups in its/their molecular structure, including for illustrative purposes and without limitation: epoxy NOVOLAC D.E.N.® 438 resin, D.E.R.® 354 resin, and NOVOLAC D.E.N.® 431 resin, (all trademarks of the Dow Chemical Company), ARALDITE® EPN 1180 resin (Ciba-Geigy) as well as other epoxy resins and precursors mentioned in U.S. Pat. No. 7,550,550. All US patents mentioned in this specification are herein fully incorporated by reference thereto. Essentially any organic molecule having two epoxy groups are generally suitable as raw materials from which epoxy polymers is provided by admixture with a polyamine. The curing component of an epoxy coating formulation is any organic polyamine that is known to be useful in the art for producing curable epoxy compositions, including without limitation all polyamino compounds described, specifically recited, and/or incorporated by reference herein, including primary and secondary polyamines, including aliphatic, aromatic and polyether polyamines. Thus, the amine-containing component typically comprises one or more organic polyamino compound(s) which have at least one active hydrogen on each of two nitrogen atoms present on a single molecule of such compound(s), or in a mixture of two or more of such polyamino compounds. A hydrogen atom is considered to be an active (or reactive) hydrogen for purposes of the instant disclosure if it is capable of participating in the Zerevitinov reaction (Th. Zerevitinov, Ber. 40, 2023 (1907)) to liberate methane from methylmagnesium bromide. Any polyamine compound having at least two nitrogen atoms in its molecular structure, wherein each of at least two of the nitrogen atoms present in the molecule have at least one active hydrogen atom attached to them, are suitable as components of the (B) component from which an epoxy composition useful for providing a first layer 5 according to the present disclosure is derived. Suitable amines include, without limitation, N-aminoethylpiperazine; diethylenetriamine; triethylenetetramine; tetraethylenepentamine; 2-methylpentamethylene; 1,3-pentanediamine; trimethylhexamethylene diamine; polyamides; polyamidoamines; Mannich-base diamines and triamines; bis(aminomethyl)cyclohexylamine; isophorone diamine; menthane diamine; bis(p-aminocyclohexyl)methane; 2,2′-dimethyl bis(p-aminocyclohexyl)methane; dimethyldicyclohexylmethane); 1,2-diaminocyclohexane; 1,4-diaminocyclohexane; meta-xylene diamine; norbornanediamine; meta-phenylene diamine; diaminodiphenylsulfone; methylene dianiline; JEFFAMINE® D-230 amine; JEFFAMINE® D-400 amine; JEFFAMINE® T-403 amine; and diethyltoluenediamine. Also suitable are blends comprised of mid- to high-molecular weight polyether polyamines, low-molecular weight amine chain extenders, and other optional additives such as pigments, adhesion promoters, and light stabilizers. The polyether polyamines may serve as the mid- to high-molecular weight amine components and are a building block in the soft block segments of a layer 5, 9 provided herein. In one embodiment, suitable polyether amines include those commercially available from Huntsman LLC of The Woodlands, Tex., including without limitation amines, JEFFAMINE® D-2000 amines, and JEFFAMINE® T-5000 amines, and substantial functional equivalents thereof from other suppliers including BASF. According to some embodiments, a two-component aqueous based epoxy dispersion coating material that is suitable for providing a first layer 5 is the material known as CFFS-711™ coating, available from Citadel.

In alternate embodiments, the first layer 5 comprises a urethane polymer (polyurethane) that is provided by applying a flowable coating composition containing polyurethane polymer precursors to the substrate 3. Suitable urethane polymer coating compositions for providing a first layer 5 include single-component solvent-based moisture-cure polyurethane materials such as the material known as CFFS-511™ coating product, available from Citadel, and functional equivalents thereof. In other embodiments, water-based polyurethane coating materials are used as a composition from which the first layer 5 is provided. Thus, single-component and two-part polyurethane coating compositions are useful for providing a first layer 5 herein.

Two-part coating composition materials are known to comprise an “A” component and a “B” component, which are generally mixed together just prior to their application to a substrate. The “A” component, or organic poly-isocyanate component useful in providing a polyurethane (or polyurea) coating composition from which one or more layers of a multi-layer structure is provided herein, may comprise any number of suitable aromatic or aliphatic-based prepolymers or quasi-prepolymers as a component. These include standard isocyanate compositions known to those skilled in the art. Some illustrative examples include MDI-based quasi-prepolymers such as those available commercially as RUBINATE® 9480, RUBINATE®. 9484, and RUBINATE® 9495 from Huntsman. The isocyanates employed in component “A” can include aliphatic isocyanates described in U.S. Pat. No. 4,748,192. These include aliphatic di-isocyanates and, more particularly, are the trimerized or the biuretic form of an aliphatic di-isocyanate, such as hexamethylene di-isocyanate (“HDI”), or the bi-functional monomer of the tetraalkyl xylene di-isocyanate, such as the tetramethyl xylene di-isocyanate. Cyclohexane di-isocyanate is also to be considered a useful aliphatic isocyanate. Other useful aliphatic polyisocyanates are described in U.S. Pat. No. 4,705,814. These include aliphatic di-isocyanates, for example, alkylene di-isocyanates with 4 to 12 carbon atoms in the alkylene radical, such as 1,12-dodecane di-isocyanate and 1,4-tetramethylene di-isocyanate. Also useful are cycloaliphatic di-isocyanates, such as 1,3 and 1,4-cyclohexane di-isocyanate as well as any mixture of these isomers, 1-isocyanato-3,3,5-trimethyl-5-isocyanatomethylcyclohexane (isophorone di-isocyanate); 4,4′-,2,2′- and 2,4′-dicyclohexylmethane di-isocyanate as well as the corresponding isomer mixtures, and the like.

A wide variety of aromatic polyisocyanates may also be used in providing a coating composition from which any polymeric layer of a multi-layered coated structure of the present disclosure is provided. Aromatic polyisocyanates which are useful for this include p-phenylene di-isocyanate, polymethylene polyphenylisocyanate, 2,6-toluene di-isocyanate, dianisidine di-isocyanate, bitolylene di-isocyanate, naphthalene-1,4-di-isocyanate, bis(4-isocyanatophenyl)methane, bis(3-methyl-3-iso-cyanatophenyl)methane, bis(3-methyl-4-isocyanatophenyl)methane, and 4,4′-diphenylpropane di-isocyanate. Other aromatic polyisocyanates useful in providing any polymeric layer of this disclosure include methylene-bridged polyphenyl polyisocyanate mixtures which have a functionality of from about 2 to about 4. These latter isocyanate compounds are generally produced by the phosgenation of corresponding methylene bridged polyphenyl polyamines, which are conventionally produced by the reaction of formaldehyde and primary aromatic amines, such as aniline, in the presence of hydrochloric acid and/or other acidic catalysts. Known processes for preparing polyamines and corresponding methylene-bridged polyphenyl polyisocyanates therefrom are described in the literature and in many patents, for example, U.S. Pat. Nos. 2,683,730; 2,950,263; 3,012,008; 3,344,162 and 3,362,979. Methylene-bridged polyphenyl polyisocyanate mixtures often contain about 20 to about 100 weight percent methylene di-phenyl-di-isocyanate isomers, with the balance being polymethylene polyphenyl di-isocyanates having higher functionalities and higher molecular weights. Typical of these are polyphenyl polyisocyanate mixtures containing about 20 to about 100 weight percent di-phenyl-di-isocyanate isomers, of which about 20 to about 95 weight percent thereof is the 4,4′-isomer with the remainder being polymethylene polyphenyl polyisocyanates of higher molecular weight and functionality that have an average functionality of from about 2.1 to about 3.5. These isocyanate mixtures are known, commercially available materials and can be prepared by the process described in U.S. Pat. No. 3,362,979. One useful aromatic polyisocyanate is methylene bis(4-phenylisocyanate) or MDI. Pure MDI, quasi-prepolymers of MDI, modified pure MDI, etc. are useful to prepare coatings suitable for employment as providing one or more layers herein. Since pure MDI is a solid and, thus, often inconvenient to use, liquid products based on MDI or methylene bis(4-phenylisocyanate) are also useful herein. U.S. Pat. No. 3,394,164 describes a liquid MDI product. Uretonimine modified pure MDI is also useful. This product is made by heating pure distilled MDI in the presence of a catalyst. The liquid product is a mixture of pure MDI and modified MDI. The term “isocyanate” as used herein also includes quasi-prepolymers of isocyanates or polyisocyanates with active-hydrogen containing materials. Thus, any of the isocyanates mentioned herein is used as the isocyanate component in forming or providing a polyurethane or polyurea coating composition useful as a material from which a first layer 5 or optional third layer 9 is derived, and any known polyol material useful for providing a polyurethane coating material is employed therewith. The material known as CFFS-DC™ two-part polyurethane, available from Citadel, is a flowable coating composition from which a first layer 5 or optional third layer 9 can be provided.

In other embodiments the first layer 5 or optional third layer 9 can be a polyurea layer, provided using a flowable coating composition comprising either single-component polyurea polymer precursor(s) or two-component polyurea polymer precursor(s). Single-component polyurea coating compositions are known in the art and those useful in accordance with the present disclosure include, without limitation, those described in U.S. Pat. No. 5,652,294, as well as MCI®-2027 polyurea coating available from Cortec Corporation of St. Paul Minn., PG-SCAL-10™ coating available from Poly-Granite International, Inc. of Wilmington Calif., CHEMTHANE® 1400 coating available from Chemline Incorporated of St. Louis, Mo., Garage Coat™ product, Poly-100 SC™ product, and Polyl-HD™ product available from Citadel. Such single-component polyureas are typically dispersions as is the case with some epoxies, as is known in the art. Single-component polyurea coatings which cure to enable a motorized vehicle as defined herein to be driven on the applied coatings in two hours after their application to the substrate without any of the polyurea material adhering to the vehicle's tires are employed in providing a coated substrate according to this disclosure.

Two-part polyurea coating compositions suitable for providing a first layer 5 or optional third layer 9 of a multi-layer coated structure provided herein include those produced from mixing any isocyanate and any polyamine described or referenced in this disclosure. Mixing is accomplished using conventional mixing equipment as well as that described in my now-abandoned U.S. patent application having Ser. No. 11/656,112, or using mixing and spray equipment manufactured by the Gusmer Company or Graco Company, as such equipment is well-known in the art, or by mechanical mixing of separate liquid components to provide a flowable polymer precursor composition. Two-component polyurea coating compositions that contain polyurea precursors useful in accordance with this disclosure as first layer 5 and optional third layer 9 materials include Polyurea Topcoat™ product, RG-80X™ product, and PG-100™ product, all available from Citadel.

Some properties of two materials suitable as a first layer 5 or optional third layer 9 material are specified in Table I below:

TABLE I
properties of some materials suitable as layers herein

| | Vol. | Wt. % | Visc | Pot | V.O.C. | | Layer |
|---|---|---|---|---|---|---|---|
| Material | Solids | Solids | cP@25° C. | Life | Lbs./gal. | TFT | Thickness |
| CFFS-511 ™ | 54% | — | — | n/a | 3.3 | 4 hrs | 0-3 mil |
| CFFS-711 ™ | 46% | 60% | 500 | >3 hrs | 0 | 2 hrs | 0-2 mil |

Additionally, the CFFS-511™ moisture-cure polyurethane material has a maximum weight loss (ASTM D-4060) of 28 mg., and a direct impact resistance of 160 in. lb. and an indirect impact resistance of 160 in. lb. (ASTM D-2794). The CFFS-711 ™ material has a pencil hardness of 2H, a ¼ inch mandrel (ASTM D1737) bend value of 180°, a direct impact value of 50 in. lb. (ASTM D-2794), and a reverse impact (Gardner Company test procedure most commonly used on such coatings) value of 4 in. lb.

In some embodiments it is desirable to provide onto a substrate 3 a coating composition from which the first layer 5 is derived at a coverage rate that permits it to have a cure time of 1-2 hours, so that application of a subsequent layer of broadcast material 7 can be effected prior to the tack-free-time (TFT) of the coating composition, which is in some embodiments about 45 minutes to one hour, in order that the multi-layered coated substrate according to this disclosure is completed well within a single day's time, in some embodiments less than 12 hours and in other embodiments in less than about five hours. Longer cure times (sufficient for application of the layer of broadcast material 7 atop the first layer 5) for the first layer 5 are permissible, provided that the coverages and ambient conditions for the remaining layers overall are favorable for a quick installation of a completed multi-layered coating. Thus, the coating composition employed for providing a first layer 5 can be selected from the group consisting of: epoxy coatings, polyurethane coatings, and polyurea coatings. Within the meaning of polyurea for purposes of this disclosure and the appended claims are polyurea coatings that are provided using an aspartic ester as a component of the flowable precursor composition. In some embodiments aqueous polymer dispersions are applied for cases when the ambient temperature is above about 40° Fahrenheit and when ambient temperatures are below about 40° Fahrenheit, solvent-based dispersions such as CFFS-511™ coating are desirably employed to facilitate spreading of the flowable composition over the substrate.

In some embodiments, the first layer 5 or optional third layer 9 when selected to be present has a tack-free time of about 4 hours, the tack-free time (“TFT”) being the amount of time between the application of the layer and the time at which the surface of the layer 5 (or 9) does not transfer to other substrates. For example, prior to the TFT, a finger touched on a laid first layer 5 will adsorb some of the material of the first layer 5. One method of testing for this is to depress a clean finger onto the first layer 5 some time after it has been laid, sufficiently to leave an indentation and then slowly drawn away. The first point in time after laying the first layer 5 at which no material adheres to the fingertip so contacted is the TFT. This same criteria useful for adjudging the TFT of the optional third layer 9, when selected to be present. In other embodiments, the first layer 5 has a TFT of about 3 hours. In other embodiments, the first layer 5 has a TFT of about 2 hours. In other embodiments, the first layer 5 or optional third layer 9 when selected to be present has a TFT of about 45 minutes. In other embodiments, the first layer 5 or optional third layer 9 when selected to be present has a TFT of any value between about 45 minutes and four hours. The TFT for a first layer 5 or optional third layer 9 when selected to be present is dependent upon the thickness at which the layer is applied, the ambient temperature, and the chemical makeup of the coating composition employed.

In some embodiments, the composition from which the first layer 5 or optional third layer 9 when selected to be present is produced is an aqueous epoxy composition that is applied to the substrate 3 or layer of broadcast material 7 at a rate of about 400 ft²/gallon, yielding a finished first layer having an average thickness of about 1.9 mils. In other embodiments, the composition from which the first layer 5 or optional third layer 9 when selected to be present is produced is an aqueous epoxy composition that is applied to the substrate 3 or layer of broadcast material 7 at a rate of about 300 ft²/gallon, yielding a finished first layer having an average thickness of about 2.5 mils. In other embodiments, the composition from which the first layer 5 or optional third layer 9 when selected to be present is produced is an aqueous epoxy composition that is applied to the substrate 3 or layer of broadcast material 7 at a rate of about 200 ft²/gallon, yielding a finished first layer having an average thickness of about 4.8 mils. Other embodiments using aqueous epoxy dispersions having first layers 5 or optional third layer 9 when selected to be present with average thicknesses that reside between the above values are readily produced by extrapolation of the coverage rate to the thickness desired.

In other embodiments, the composition from which the first layer 5 or optional third layer 9 when selected to be present is produced is a moisture-cure polyurethane coating composition that is applied to the substrate 3 or layer of broadcast material 7 at a rate of about 400 ft²/gallon, yielding a finished first layer having an average thickness of about 2.4 mils. In other embodiments, the composition from which the first layer 5 or optional third layer 9 when selected to be present is produced is a moisture-cure polyurethane composition that is applied to the substrate 3 or layer of broadcast material 7 at a rate of about 325 ft²/gallon, yielding a finished first layer having an average thickness of about 3 (three) mils. In other embodiments, the composition from which the first layer 5 or optional third layer 9 when selected to be present is produced is a moisture-cure polyurethane composition that is applied to the substrate 3 or layer of broadcast material 7 at a rate of about 200 ft²/gallon, yielding a finished first layer having an average thickness of about 5 (five) mils. Other embodiments having a first layer 5 or optional third layer 9 when selected to be present with average thicknesses that resided between the above values is readily produced using a moisture cure polyurethane composition by extrapolation of the coverage rate to the thickness desired. The foregoing values and ranges are applicable to instances when two-component polyurethane compositions are selected to be used in providing a first layer 5 or optional third layer 9 when third layer 9 is selected to be present.

In other embodiments, the composition from which the first layer 5 or optional third layer 9 when selected to be present is produced is a moisture-cure polyurea coating composition that is applied to the substrate 3 or layer of broadcast material 7 at a rate of about 400 ft²/gallon, yielding a finished first layer having an average thickness of about 1.9 mils. In other embodiments, the composition from which the first layer 5 or optional third layer 9 when selected to be present is produced is a moisture-cure polyurea composition that is applied to the substrate 3 or layer of broadcast material 7 at a rate of about 325 ft²/gallon, yielding a finished first layer having an average thickness of about 2.7 mils In other embodiments, the composition from which the first layer 5 or optional third layer 9 when selected to be present is produced is a moisture-cure polyurea composition that is applied to the substrate 3 or layer of broadcast material 7 at a rate of about 200 ft²/gallon, yielding a finished first layer having an average thickness of about 4.8 mils. Other embodiments having a first layer 5 or optional third layer 9 when selected to be present with average thicknesses that resided between the above values is readily produced using a moisture cure polyurea composition by extrapolation of the coverage rate to the thickness desired. The foregoing values and ranges are applicable to instances when two-component polyurea compositions are selected to be used in providing a first layer 5 or optional third layer 9 when third layer 9 is selected to be present.

Regardless of the material used for the first layer 5 or optional third layer 9 when selected to be present, after curing the average thickness of such layers is any average thickness in the range of between about 0.8 mils and about 3.2 mils or greater, up to about 15 mils if desired, including all average thicknesses and ranges of thicknesses within the range of 0.8-15 mils. In general, the coating composition employed for the top layer 5 or optional third layer 9 when selected to be present should be applied at a rate sufficient to enable the layer to have a thickness of any value between about 2 mils and about 15 mils, after curing, including all average thicknesses and ranges of average thicknesses within the range of 2 to 15 mils, with average thicknesses in the range of about 2 to 7 mils being desirable in some embodiments of this disclosure.

While particular materials have been described as being suitable as first layer 5 coating materials in a multi-layer coated structure provided herein, one of ordinary skill immediately recognizes after reading this disclosure that other commercially-available epoxy, polyurethane, and polyurea coating materials, both aqueous and solvent-based are potentially suitable for employment as materials from which a first layer 5 is provided.

The layer of broadcast material 7 of a multi-layered coated substrate as shown in FIG. 1 is comprised of a plurality of solid particles, which in some embodiments comprises particles of mineral matter, but is not limited to mineral matter, and may comprise non-mineral matter. A handful of pea-sized gravel is a plurality of solid particles within the definition of plurality of solid particles. Mineral matter includes all known minerals, as the word “mineral” is understood by geologists and others skilled in the mineral-related arts, that are solids at 75 degrees centigrade. Aggregates are minerals within this class, and all aggregates disclosed within the document entitled: “Natural Aggregates of the Conterminous United States” by William H. Langer (U.S. Geological Survey Bulletin 1594, second printing, 1993), the entire contents of which are herein incorporated by reference, are suitable for use in providing a layer of broadcast material 7 within the context of the present disclosure. Suitable solid particles which may comprise the layer of broadcast material 7 include without limitation sand, crushed glass, calcium carbonate, seashells, stone, crushed stone, gravel, quartz, flints, cherts, and aluminum oxides (corundums) of various average particle sizes, which is any average particle size in the range of between one micron and three millimeters, and including all average sizes and ranges of average sizes therebetween. The exact particle size may or may not be critical to the functioning of a multi-layered coating according to this disclosure, depending upon the material selected as the material from which the layer of broadcast material 7 is comprised. For example, when metal turnings are selected as the particle from which the layer of broadcast material 7 is comprised, they can be of much larger average particle size than when sand is used, but may still be effective for providing an anti-skid surface. In some embodiments, the function of the layer of broadcast material 7 is to provide increased friction on the surface of the finished multi-layer coating produced in accordance with the instant disclosure. Essentially any average particle size in the range of between about 100 microns to 2.0 centimeters in diameter are suitable, including every tenth millimeter increment within such range and all ranges therebetween, when the particles are substantially spherical. However, as in the case of metal turnings, or crushed glass, chipped chert, chipped flint, etc. having irregular shape, the length dimension of the particle is somewhat longer than its width dimension, and the particles may have any average length between about 100 microns to about 2 centimeters, including every tenth millimeter increment within such range and all ranges of sizes therebetween. In some embodiments, the layer of broadcast material 7 is comprised of recycled crushed glass. In other embodiments, the layer of broadcast material 7 is comprised of sand, having an average particle size between about 1 and 2 millimeters, such as the “play sand” suitable for use in children's sandboxes commonly sold at retail outlets. In other embodiments, the layer of broadcast material 7 is comprised of a fractured flint product such as fractured flint #2 supplied by Sterling Supply in Minneapolis Minn. In other embodiments, the layer of broadcast material 7 is comprised of obsidian particles. In other embodiments, the layer of broadcast material 7 is comprised of ground recycled thermoplastic polyolefins particles. In other embodiments, the layer of broadcast material 7 is comprised of silica particles. Thus, the layer of broadcast material 7 can be comprised of any solid non-reactive stable material, with naturally occurring stone (crushed or non-crushed), obsidians, cherts, flints, glasses, sands and the like being frequently desirable, having average particle sizes within any of the size ranges mentioned above. The layer of broadcast material 7 may also comprise materials which impart a decorative appearance to a multi-layer coating provided by the instant disclosure. Chips of vinyl polymers, acrylic polymers and paint chips are suitable for this purpose and may have any desired coloration. Non-limiting examples are the materials available from Torginol, Inc. of Sheboygan Falls, Wis. (website http://www.torginol.com) under the tradename TORGACHIPS™ decorative chips, including all sizes and colors provided thereby or otherwise known in the art. Some useful materials include Saddle Tan ¼″ Chip™ product, ¼″ Tan Chip™ product, ¼″ Gunflint Trail Chip™ product, and any color of DecorativeChip™ product available from Citadel. The layer of broadcast material 7 is desirably applied over the first layer 5 prior to the cure of the first layer 5, in some embodiments just after the first layer 5 has been applied, to enable the particles which comprise the layer of broadcast material 7 to be adhered well to the composition of the first layer 5 owing to its tackiness whereby the first layer 5 can be thought of as functioning as an adhesive. A plurality of particles comprising a layer of broadcast material 7 according to this disclosure is used with or in any multi-layered structure disclosed herein. The thickness of the layer of broadcast material 7 is any thickness resulting from the inherent particle size of the broadcast material itself and the ability of the first layer 5 to adhere the particles of the layer of broadcast material 7 to the point of rejection, which is the point at which no more of the broadcast material is held by the first layer 5, i.e., the first layer 5 is limited in its capacity to adhere particles by virtue of its finite surface area. In some embodiments, the layer of broadcast material 7 is omitted and for purposes of some embodiments of this disclosure, the layer of broadcast material 7 is optional.

A multi-layered coated substrate 3 according to this disclosure in some embodiments comprises an optional third layer 9, which, when selected to be present is provided by applying a flowable composition containing polymer precursors to (atop) the layer of broadcast material 7, after the first layer 5 has cured sufficiently to enable a workman to tread on the surface of the first layer 5 and layer of broadcast material 7 without substantially damaging or otherwise compromising integrity of layers 5, 7.

In some embodiments, the composition employed in providing the optional third layer 9 is the same as the composition employed in providing first layer 5. Thus in some embodiments optional third layer 9 can be selected to comprise a layer of an epoxy polymer, a layer of a polyurethane polymer, or a layer of a polyurea polymer as such materials were described previously. Such layers can have a thickness, application rate, TFT and cure time selected to be within those ranges specified for the first layer 5. In some embodiments, the optional third layer 9 can, for example, comprise a layer of epoxy polymer, derived from any of the materials described above as useful for providing a first layer 5 and having thicknesses, application rates, and cure times specified for the first layer 5, but wherein the epoxy provided by the coating composition used to provide the optional third layer 9 is different from the epoxy coating composition used in providing the first layer 5. Thus, the coating composition employed to provide the optional third layer 9 can be selected to be identical to, or different from, that employed in providing the first layer 5, with each composition being within the description of the compositions suitable for providing the first layer 5. In some embodiments the coating composition from which the optional third layer 9 is provided is applied at a coating rate (sq. ft./gal.) that is greater than or less than that of the first layer 5, by any amount, wherein the coating rate for each the first layer 5 and optional third layer 9 are both within the parameters specified above for the first layer 5. Selection of a material from which layer 5 and layer 9 are comprised can each be made independently of the other layer. Thus, first layer 5 can be selected to be any polymeric layer selected from the group consisting of: epoxy polymers, polyurethane polymers, and polyurea polymers independent of the selection of polymer for optional layer 9. Optional layer 9 when selected to be present can be independently selected to be any polymeric layer from the group consisting of: epoxy polymers, polyurethane polymers, and polyurea polymers. In some embodiments first layer 5 and optional third layer 9 when selected to be present can both be selected to be comprised of the same polymer selected from the group consisting of: epoxy polymers, polyurethane polymers, and polyurea polymers.

In some embodiments, the coating composition from which the optional third layer 9 is provided comprises a polyaspartic polyurea polymer, or reactive precursors for a polyaspartic polyurea polymer, which polymers are sometimes referred to as polyaspartate ester polyureas. Coating materials comprising polyaspartate ester polyureas or precursors thereof useful in accordance with the present disclosure include, without limitation, those prepared using materials and/or components described in U.S. Pat. Nos. 6,790,925; 6,774,206; 6,774,207; 6,737,500; 6,605,684; 6,590,066; 6,458,293; 6,399,736; 6,355,829; 6,183,870; 6,169,140; 6,013,755; 5,580,945; 5,847,195; 5,736,604; 5,733,967; 5,652,301; 5,561,214; 5,559,204; 5,529,739; 5,516,873; 5,489,704; 5,236,741; 5,126,170; and 4,324,716.

Polyaspartic polyurea coating compositions useful in accordance with the present disclosure for providing an optional third layer 9 are typically formed by admixture of an (A) component and a (B) component, the (A) component comprising an organic polyisocyanate, and the (B) component is capable of reacting with the (A) component and comprises one or more polyaspartate ester compounds, wherein the polyaspartate ester compounds have a reactive hydrogen atom attached to nitrogen atoms of the aspartate ester units in the polyaspartate. Any of the isocyanates mentioned or referred to herein are employable as the isocyanate component in forming a polyaspartic polyurea coating material useful as first layer 5 and/or optional third layer 9 according to the present disclosure, either alone or in combination with other aforementioned isocyanates.

In one embodiment when the coating composition from which the optional third layer 9 is provided comprises a polyaspartic polyurea, the optional third layer 9 has a tack-free time of about 15 seconds. In other embodiments, the optional third layer 9 has a TFT of about 45 minutes to 1 hour. In other embodiments, the optional third layer 9 has a TFT of about 2 hours. In other embodiments, the optional third layer 9 has a TFT of any amount of time between about 10 minutes and 2 hours. The exact TFT's for a given composition from which a optional third layer 9 is provided depend chiefly upon the particular polyaspartic ester and isocyanate employed. In general, but not always, shorter TFT's are desirable, as is the case with all layers herein, since one aspect of this disclosure provides a durable multi-layered coating as depicted in FIG. 1 within a single day, and in some embodiments in less than 8 hours. In other embodiments this time is about 3 hours from the time the first layer 5 is contacted to the substrate 3. Generally speaking, the TFT for an optional third layer 9 is dependent upon the thickness at which the optional third layer 9 is applied, the ambient temperature, and the chemical makeup of the coating composition employed.

In some embodiments, the composition from which the optional third layer 9 is produced is a polyaspartic ester polyurea composition and is applied over the layer of broadcast material 7 at a rate of about 1600 ft²/gallon, and yields a finished third layer 9 having an average thickness of about one mil. In other embodiments, the composition from which the optional third layer 9 is produced is a polyaspartic ester polyurea composition and is applied over the layer of broadcast material 7 at a rate of about 800 ft²/gallon, and yields a finished third layer having an average thickness of about 2 mils. In other embodiments, the composition from which the optional third layer 9 is produced is a polyaspartic ester polyurea composition and is applied to the layer of broadcast material 7 at a rate of about 400 ft²/gallon, and yields a finished third layer having an average thickness of about 4 mils. In other embodiments, the composition from which the optional third layer 9 is produced is a polyaspartic ester polyurea composition and is applied to the layer of broadcast material 7 at a rate of about 320 ft²/gallon, and yields a finished third layer having an average thickness of about 5 mils. Other embodiments having an optional third layer 9 with average thicknesses that reside between the above values are readily produced by extrapolation of the coverage rate to the thickness desired.

One exemplary polyaspartic polyurea coating material useful for providing optional third layer 9 in accordance with the present disclosure is that known as CFFS-RG 70™ product available from Citadel Floor Finishing Systems of 3001 103^{rd} Lane Northeast, Blain, Minn. 55449. Another polyaspartic polyurea coating material useful for providing a optional third layer 9 in accordance with the present disclosure is that known as CFFS-RG 100™ product, available from Citadel. Typical physical properties of these products are set forth in Table II below:

TABLE II

| | | Product | |
|---|---|---|---|
| | | CFFS-RG 70 ™ | CFFS-RG 100 ™ |
| Parameter | Test Method | product | product |
| Tensile Stength | ASTM D412 | 6000 | 6000 |
| Elongation | ASTM D412 | 100 | 100 |
| Tear Strength | ASTM D2240 | 330 | 330 |
| (lbs/linear in.) | | | |
| Hardness, | ASTM D2240 | 73 | 73 |
| Shore D | | | |
| Flexibility, ⅛″ | ASTM D1737 | Pass | Pass |
| Mandrel | | | |
| Falling Sand | ASTM D 968 | 30 | 30 |
| Abrasion | | | |
| Resistance | | | |
| Tabor Abrasion | ASTM D4060 | 30 | 30 |
| mg loss | | | |
| Viscosity B- | — | 1400-1500 cP | 1400-1500 cP |
| component | | @ 75° C. | @ 75° C. |
| Viscosity, A- | — | 700-800 P | 700-800 P |
| component | | @ 75° C. | @ 75° C. |
| Gloss | ASTM D523 | >90 | >90 |

In other embodiments, a coating composition from which an optional third layer 9 is provided may comprise a polyurea polymer dispersion or precursors of polyurea polymers, which can include those selected from any of the polyamines, esters, and isocyanates previously set forth. A coating material from which an optional third layer 9 can be provided according to this disclosure is a single-component or a two-part polyurea. Any polyurea coating material made using isocyanates and polyamines, and esters specified or described herein or known in the art are useful in providing a coating material from which the optional third layer 9 is comprised, including without limitation those coatings materials specified herein as being suitable for providing a first layer 5, subject to the proviso of the time limit constraints recited. In other embodiments, a coating composition from which optional third layer 9 is provided comprises a urethane polymer (polyurethane) or precursors to polyurethane polymers, including those compositions disclosed and/or provided herein as being suitable for providing a first layer 5, subject to the proviso of the time limit constraints recited. Thus, any of the isocyanates mentioned above can be used as the isocyanate component in forming or providing a polyurethane coating composition useful as a material from which optional third layer 9 is derived, and any known polyol material useful for providing a polyurethane coating material is employed therewith.

In other embodiments, the coating composition from which the optional third layer 9 is provided comprises a polymeric urethane-modified acrylic material or precursors thereof. Essentially any urethane-modified acrylic composition that is intended or formulated for providing a coating on a substrate is suitable for use as optional third layer 9 according to this disclosure provided it is spreadable using equipment/techniques described above herein and provided it yields a urethane-modified acrylic polymer coating upon its curing, and subject to the proviso of the time limit constraints recited. These include, without limitation, such urethane-modified acrylic coatings such as: Eco-TPS™ coatings supplied by Tennant Company of Minneapolis, Minn., Product #20 and Product #35 available from Perma, Inc. of Bedford Mass., Ultra Surface Acrylic Urethane™ from Concrete Solutions of San Diego, Calif., spreadable, curable compositions comprising the urethane acrylates sold by BASF under the trademark LAROMER®, and SHERTHANE® 2K urethane coating from the Sherwin-Williams Company of Cleveland Ohio. One useful composition comprising a urethane-modified acrylic in dispersion form is that known as ORDCLR/W™ product, available from Citadel, which can also be used in providing a first layer 5 according to this disclosure. Some physical parameters of ORDCLR/W™ product are set forth in Table III below. The rating key for the chemical spot tests performed on the cured material is: 10=no effect; 5=moderate swelling, softening and whitening; and 0=completely dissolved.

TABLE III

| | |
|---|---|
| Gloss, 60° (ASTM D 523) | 74 |
| Solids (by weight %) | 40 |
| Impact Resistance (ASTM D 2794) | |
| Direct and Reverse, in-lb | >160 |
| Flexibility, % | |
| Conical Mandrel Bend (ASTM D 522) | >32 |
| Tensile Strength (psi) | 4400 |
| Elongation, % | >32 |
| Hardness | |
| Persoz, s (ASTM D 4366) | 200 |
| Pencil (ASTM D 3363; scratch/gouge) | F/3H |
| Double Rubs (ASTM D 4752) | |
| Isopropanol | 90 |
| Methylethyl ketone | >200 |
| Chemical Spot Tests, 1 hour after | |
| coating | |
| Exposure (ASTM D 1308)* | |
| Household Bleach | 10 |
| Vinegar | 10 |
| Olive Oil | 10 |
| Fantastick ® Cleaner | 9 |
| 10% aqueousAmmonia | 10 |
| Isopropanol | 7 |
| 50% Ethanol/water | 8 |

The thickness of the optional third layer 9, regardless of the material which it comprises, can in some embodiments be any thickness in the range of between about 0.8 mil and about 15 mils, including all ranges within the range of 0.8-15 mils with thicknesses between about 2.8 and 4 mils being employed in many embodiments.

The following examples shall be construed as but a few possible alternate embodiments of the teachings of the present disclosure, and not delimitive of this disclosure:

### Example 1

This example concerns creation of a same-day floor coating made using a single coat of tinted single component aromatic polyurea product on a concrete substrate. A concrete slab floor is first etched with RockSolid Floors Safe Etch™ cleaner from Citadel Floor Finishing Systems of 3001 103^{rd} Lane Northeast, Blaine, Minn. 55449 (“Citadel”), per manufacturer's instructions. After the floor has dried for 2-3 hours RockSolid Floors Floors Garage Coat™ is used to coat the concrete. The RockSolid Floors Garage Coat™ product is supplied by the manufacturer in a pouch. The pouch is opened and a RockSolid Floors Garage Coat Tint Shot™ Tan colorant packet is added to the contents of the pouch to form a mixture. The mixture is made homogeneous by manually shaking the pouch for 1 minute. The mixed contents of the pouch are then poured out in ribbons directly to the concrete slab. Working in 4′×4′ sections, the material is spread evenly with an “m” and “w” pattern using a foam ¼″ nap roller at a rate of 500 square feet per gallon. Upon completion of the 4′×4′ sections with the RockSolid Floors Garage Coat™ product, if desired, RockSolid Floors Decorative Chip™ material is broadcast to achieve a random, partial chip appearance. Upon completion of broadcasting the Decorative Chip™ material, the next 4′ section is coated using the same “m” and “w” pattern followed by the same broadcast of decorative chip. This process is followed for the remainder of the square footage until the concrete slab is covered with RockSolid Floors Tan Garage Coat™ and RockSolid Floors™ decorative chip. The floor is ready for foot traffic in 6 hours, and full service in 24 hours.

### Example 2

This example concerns creation of a same-day floor coating made using a single coat of tinted single component aromatic polyurea product, followed by application of a two-component aliphatic polyurea coating atop a concrete substrate. A concrete floor is etched with RockSolid Floors Safe Etch™ from Citadel per manufactures instructions. After the floor has dried for 2-3 hours RockSolid Floors Garage Coat™ is used to coat this slab. The RockSolid Floors Garage Coat™ pouch is opened and the RockSolid Floors Garage Coat Tint Shot™ Grey is added to the pouch. This material is made homogeneous by shaking the pouch for 1 minute. Mixed material is then poured out in ribbons directly to the concrete slab. Working in 4′×4′ sections the material is spread evenly with an “m” and “w” pattern using a foam ¼″ roller at 500 square feet per gallon. Upon completion of the 4′×4′ section with the RockSolid Floors Garage Coat™, RockSolid Floors™ Decorative Chip is broadcast to achieve a random, partial chip look. Upon completion of broadcasting the chip, the next 4′×4′ section is coated using the same “m” and “w” pattern followed by the same broadcast of decorative chip. This process is followed for the remainder of the square footage until the concrete slab is covered with the RockSolid Floors Grey Garage Coat™ and RockSolid Floors™ decorative chip. After 4-6 hours of cure time, RockSolid Floors Polyurea Topcoat™ is mixed per manufacturer's instructions and applied to the floor using a ⅜″ nap roller dipping out of a pan. Working in 4′×4′ sections the RockSolid Floors Polyurea Topcoat™ is spread via an “m” and “w” pattern at 500 square feet per gallon. The next 4′×4′ section is coated using the same “m” and “w” pattern. This process is followed for the remainder of the square footage until the concrete slab is covered with RockSolid Floors Polyurea Topcoat™. The floor is ready for foot traffic in 6 hours and full service in 24 hours.

### Example 3

This example concerns creation of a same-day floor coating made using a single coat of tinted single component aromatic polyurea coating atop a concrete substrate. A concrete floor is diamond ground with 40 grit segmented diamonds and all dust and debris is subsequently collected utilizing a vacuum. 128 oz (1 gallon) of CFFS Poly-100 SC™ clear from Citadel is mixed via a low speed drill with 12% by volume (15.36 oz) Grey-Universal Industrial Tint™ (Citadel) into a 5 quart bucket. The tinted Poly-100 SC™ is roll applied out of a pan onto the concrete slab. Working in 4′×4′ sections the Grey tinted Poly-100 SC™ is applied with an “m” and “w” pattern utilizing a ⅜″ nap roller at 400 square feet per gallon. Upon completion of the 4′×4′ section with CFFS Poly-100 SC™, Citadel's Decorative Chip™ product is broadcast to achieve a random, partial chip look. Upon completion of broadcasting the chip, the next 4′×4′ section is coated using the same “m” and “w” pattern followed by the same broadcast of decorative chip. This process is followed for the remainder of the square footage until the concrete slab is covered with CFFS Poly-100 SC™ and decorative chip. The floor is ready for foot traffic in 6 hours and full service in 24 hours.

### Example 4

This example concerns creation of a same-day floor coating made using a single coat of tinted single component aromatic polyurea product, followed by application of a single component aliphatic polyurea coating atop a concrete substrate. A concrete floor is diamond ground with 40 grit segmented diamonds and all dust and debris is subsequently collected utilizing a vacuum. 128 oz (1 gallon) of Poly-100 SC™ clear (Citadel) is mixed via a low speed drill with 12% by volume (15.36 oz) Grey-Citadel Universal Industrial Tint™ product into a 5 quart bucket. The tinted Poly-100 SC™ is roll applied out of a pan onto the concrete slab. Working in 4′×4′ sections the Grey tinted Poly-100 SC™ is applied with an “m” and “w” pattern utilizing a ⅜″ nap roller at 400 square feet per gallon. Upon completion of the 4′×4′ section with Poly-100 SC™, Citadel's Decorative Chip™ product is broadcast to achieve a random, partial chip look. Upon completion of broadcasting the chip, the next 4′×4′ section is coated using the same “m” and “w” pattern following the same broadcast of decorative chip. This process is followed for the remainder of the square footage until the concrete slab is covered with CFFS Poly-100 SC™ and decorative chip. After 4-6 hours of cure time, Polyurea-1-HD™ product from Citadel is mixed and applied to the floor using a ⅜″ nap roller dipping out of a pan. Working in 4′×4′ sections CFFS Poly-1-HD™ is spread via an “m” and “w” pattern at 500 square feet per gallon. The next 4′×4′ section is coated using the same “m” and “w” pattern. Once a 4′ strip has been coated across the width of the floor a final cross roll is done, wearing spiked shoes, to ensure an even coating. This process is followed for the remainder of the square footage until the concrete slab is covered with CFFS Polyurea-1-HD™. The floor is ready for foot traffic in 6 hours, and full service in 24 hours.

### Example 5

This example concerns creation of a same-day floor coating made using a single coat of tinted single component aromatic polyurea product, followed by application of a two-component aliphatic polyurea coating atop a concrete substrate. A concrete floor is diamond ground with 40 grit segmented diamonds and all dust and debris is subsequently collected utilizing a vacuum. 128 oz (1 gallon) of CFFS Poly-100 SC™ clear is mixed via a low speed drill with 12% by volume (15.36 oz) Grey-Citadel Universal Industrial Tint™ product into a 5 quart bucket. The tinted Poly-100 SC™ is roll applied out of a pan onto the concrete slab. Working in 4′×4′ sections the Grey tinted Poly-100 SC™ is applied with an “m” and “w” pattern utilizing a ⅜″ nap roller at 400 square feet per gallon. Upon completion of the 4′×4′ section with CFFS Poly-100 SC™, Citadel's Decorative Chip™ product is broadcast to achieve a random, partial chip look. Upon completion of broadcasting the chip, the next 4′×4′ section is coated using the same “m” and “w” pattern followed by the same broadcast of decorative chip. This process is followed for the remainder of the square footage until the concrete slab is covered with CFFS Poly-100 SC™ and decorative chip. After 4-6 hours of cure time, CFFS RG-80×™ part A and B are mixed per manufacturing instructions and applied to the floor using a ⅜″ nap roller dipping out of a pan. Working in 4′×4′ sections CFFS RG-80x™ is spread via an “m” and “w” pattern at 500 square feet per gallon. The next 4′×4′ section is coated using the same “m” and “w” pattern. Once a 4′ strip has been coated across the width of the floor a final cross roll is done with the operator wearing spiked shoes, to ensure an even coating. This process is followed for the remainder of the area until the concrete slab is covered with CFFS RG-80x™ product. The floor is ready for foot traffic in 6 hours and full service in 24 hours.

### Example 6

This example concerns creation of a same-day floor coating made using a single coat of tinted single component aromatic polyurea product, followed by application of a two-component aliphatic polyurea coating atop a concrete substrate. A concrete floor is diamond ground with 40 grit segmented diamonds and all dust and debris is subsequently collected utilizing a vacuum. 128 oz (1 gallon) of CFFS Poly-100 SC™ clear is mixed via a low speed drill with 12% by volume (15.36 oz) Grey Citadel Universal Industrial Tint™ product in a 5 quart bucket. The tinted Poly-100 SC™ is roll applied out of a pan onto the concrete slab. Working in 4′×4′ sections the Grey tinted Poly-100 SC™ product is applied with an “m” and “w” pattern utilizing a ⅜″ nap roller at 400 square feet per gallon. Upon completion of the 4′ section across the width of the slab broadcast decorative chip, until rejection, into the wet CFFS Poly-100 SC™ product leaving at least 12″ of wet coating to roll back into. Upon completion of broadcasting the chip, the next 4′ section is coated using the same “m” and “w” pattern following the same broadcast of decorative chip. This process is followed for the remainder of the square footage until the concrete slab is covered with CFFS Poly-100 SC™ product and decorative chip. After 1 hour, a leaf blower or broom is employed to push the loose chip into a corner for recovery. Then a floor scraper or putty knife is used to scrape the floor in two directions. Once this is complete, the un-adhered chip material is collected and recovered. A vacuum is employed to clean the entire floor in two directions. Upon completion of vacuuming, CFFS PG-100™ product (Citadel) part A and B are mixed according to manufacturer instructions. The mixed material is then poured out in ribbons directly over the cured full chip coating. Using a flat blade the product is spread evenly across the width of the floor until a 4′ section is coated in a thin and even layer at 160 square feet per gallon of coverage rate. Wearing spiked shoes, a ⅜″ nap roller is saturated with the mixed CFFS PG-100™ product and the material is rolled onto the substrate in an “m” and “w” pattern to help evenly spread the coating. A final cross roll spanning the length of the 4′ strip is subsequently done to ensure an even coating. Continue to pour out a ribbon of material, squeegee, roll in an “m” and “w” pattern and cross roll until the entire surface has been coated. The floor is ready for foot traffic in 6 hours and full service in 24 hours.

### Example 7

This example concerns creation of a same-day floor coating made using a single coat of tinted single component aromatic polyurea product, followed by application of a two-component aliphatic polyurea coating, atop a concrete substrate. A concrete floor is diamond ground with 40 grit segmented diamonds and all dust and debris is subsequently collected utilizing a vacuum. 128 oz (1 gallon) of Poly-100 SC™ clear product (Citadel) is mixed via a low speed drill with by volume 12% (15.36 oz) Grey Citadel Universal Industrial Tint™ product in a 5 quart bucket. The tinted Poly-100 SC™ is roll applied out of a pan onto the concrete slab. Working in 4′×4′ sections the Grey tinted Poly-100SC™ material is applied with an “m” and “w” pattern utilizing a ⅜″ nap roller at a rate of 400 square feet per gallon. Upon completion of the 4′ section across the width of the slab is broadcast a chip material, until rejection, into the wet CFFS Poly-100 SC™ product leaving at least 12″ of wet coating to roll back into. Upon completion of broadcasting the chip, the next 4′ section is coated using the same “m” and “w” pattern following the same broadcast of chip. This process is followed for the remainder of the square footage until the concrete slab is covered with CFFS Poly-100 SC™ product and decorative chip. After 1 hour, a leaf blower or broom is employed to push the loose chip into a corner for recovery. A floor scraper or putty knife is then used to scrape the floor in two directions. Once this is complete, un-adhered loose chip is removed and collected. A vacuum is employed to clean the entire floor in two directions. Upon completion of vacuuming, CFFS RG-80x™ product (Citadel) part A and B are mixed according to manufacturer instructions. The mixed material is then poured out in ribbons directly over the adhered chips. Using a flat blade squeegee, the product is evenly spread across the width of the floor until a 4′ section is coated in a thin and even layer at a rate of 200 square feet per gallon. A ⅜″ nap roller is saturated with the mixed CFFS RG-80x™ product and the coating is rolled in an “m” and “w” pattern to help evenly spread the coating. A final cross-roll spanning the length of the 4′ strip is then done to ensure an even coating. Continue to pour out a ribbon of material, squeegee, roll in an “m” and “w” pattern and cross roll until the entire surface has been coated. Floor is than ready for foot traffic in 6 hours and full service in 24 hours.

### Example 8

This example concerns creation of a same-day floor coating made using a single coat of tinted single component aromatic polyurea product, followed by application of a two-component aliphatic polyurea coating, atop a linoleum substrate. A linoleum floor is first sanded with 80 grit sandpaper and then cleaned with acetone. 128 oz (1 gallon) of CFFS Poly-100 SC™ clear product is mixed via a low speed drill with 12% by volume (15.36 oz) Grey Citadel Universal Industrial Tint™ product in a 5 quart bucket. The tinted Poly-100 SC™ material is roll applied out of a pan onto the concrete slab. Working in 4′×4′ sections the Grey tinted Poly-100 SC™ material is applied with an “m” and “w” pattern utilizing a ⅜″ nap roller at 400 square feet per gallon. Upon completion of the 4′ section across the width of the slab broadcast decorative chip, until rejection, into the wet CFFS Poly-100 SC™ material leaving at least 12″ of wet coating to roll back into. Upon completion of broadcasting the chip, the next 4′ section is coated using the same “m” and “w” pattern following the same broadcast of decorative chip. This process is followed for the remainder of the square footage until the concrete slab is covered with CFFS Poly-100 SC™ material and decorative chip. After 1 hour, a leaf blower or broom is used to push the loose chip into a corner for recovery. A floor scraper or putty knife is then used to scrape the floor in two directions. Once this is complete loose chip is collected and recovered. A vacuum is used to clean the entire floor in two directions. Upon completion of vacuuming, CFFS PG-100™ product part A and B (Citadel) are mixed according to manufacturer instructions. The mixed material is then poured out in ribbons directly over the cured full chip coating. Using a flat blade squeegee, the product is spread evenly across the width of the floor until a 4′ section is coated in a thin and even layer at 160 square feet per gallon. A ⅜″ nap roller is saturated with the mixed CFFS PG-100™ material which is then rolled onto the substrate in an “m” and “w” pattern to help evenly spread the coating. A final cross roll spanning the length of the 4′ strip is then done to ensure an even coating. Continue to pour out a ribbon of material, squeegee, roll in an “m” and “w” pattern and cross roll until the entire surface has been coated. Floor is than ready for foot traffic in 6 hours and full service in 24 hours.

### Example 9

This example concerns creation of a same-day floor coating made using a single coat of tinted single component aromatic polyurea product, followed by application of a two-component aliphatic polyurea coating atop a concrete substrate. Onto a plywood subfloor, Kilz® Original Primer from Masterchem Industries, Imperial, Mo. is installed per the manufacturer's instructions onto the subfloor. After 1 hour, RockSolid Floors Garage Coat™ (Citadel) supplied in a pouch is used to coat this slab. The RockSolid Floors Garage Coat™ pouch is opened and the RockSolid Floors Garage Coat Tint Shot™ Grey is added to the pouch. This material was mixed by shaking the pouch for 1 minute. The mixed material was then poured out in ribbons directly to the concrete slab. Working in 4′×4′ sections the material was spread evenly with an “m” and “w” pattern using a foam ¼″ roller at a rate of 500 square feet per gallon. Upon completion of the 4′×4′ section with the RockSolid Floors Garage Coat™, RockSolid Floors™ Decorative Chip is broadcast to achieve a random, partial chip look. Upon completion of broadcasting the chip, the next 4′×4′ section is coated using the same “m” and “w” pattern following the same broadcast of decorative chip. This process is followed for the remainder of the square footage until the concrete slab is covered with the RockSolid Floors Grey Garage Coat™ and RockSolid Floors™ decorative chip. After 4-6 hours of cure time, RockSolid Floors Polyurea Topcoat™ is mixed per manufacturer's instructions and applied to the floor using a ⅜″ nap roller dipping out of a pan. Working in 4′×4′ sections the RockSolid Floors Polyurea Topcoat™ is spread via an “m” and “w” pattern at a rate of 500 square feet per gallon. The next 4′×4′ section is coated using the same “m” and “w” pattern. This process is followed for the remainder of the square footage until the concrete slab is covered with RockSolid Floors Polyurea Topcoat™. The floor is ready for foot traffic in 6 hours and full service in 24 hours.

To provide coatings on substrates which cure sufficiently in two hours time to enable a motorized vehicle as defined herein to pass over such a layered substrate as provided herein without the coating material adhering to the vehicle's tires, the product Poly-100 SC FAST™ from Citadel is suitably employed as in the examples. An alternate material suitable for providing coatings on substrates which cure sufficiently in two hours time to enable a motorized vehicle as defined herein to pass over such a layered substrate as provided herein without the coating material adhering to the vehicle's tires, the product PG-100 SC FAST™ from Citadel is suitably employed as in the examples.

Thus, the present disclosure provides various embodiments of multi-layered coated structures which in some embodiments comprise: a) a substrate; b) a first layer disposed over the substrate, the first layer comprising a coating material selected from the group consisting of: epoxy polymer coatings, polyurea polymer coatings, urethane polymer coatings and urethane-modified acrylic coatings; c) a layer of broadcast material comprising a plurality of particles disposed over the first layer; d) an optional third layer disposed over the layer of broadcast material wherein the third layer comprises a coating material selected from the group consisting of: polyaspartic polyurea polymer coatings, polyurea polymer coatings, urethane polymer coatings, urethane-modified acrylic polymer coatings and epoxy polymer coatings. For some instances in which the user of technology as taught herein does not desire the optional third layer 9 to be present, it is merely omitted.

In certain embodiments, the substrate is a horizontal concrete surface and the polymer layer(s) present cure sufficiently to enable passage of a motorized vehicle over the substrate within twenty-four hours of initial application of the first layer to the substrate, and whereby the multi-layered structure of this disclosure does not experience any detrimental change by the passage of the motorized vehicle over the substrate.

In other embodiments, the substrate is a horizontal concrete surface and the polymer layer(s) present cure sufficiently to enable passage of a motorized vehicle over the substrate within fourteen hours of initial application of the first layer to the substrate, and whereby the multi-layered structure of this disclosure does not experience any detrimental change by the passage of the motorized vehicle over the substrate. A motorized vehicle for purposes of this disclosure in context of determining cure of a polymeric coating herein is a 2005 Ford F-150½ ton pickup truck in its base stock configuration. In other embodiments, the substrate is selected to be a horizontal concrete surface and the top layer is sufficiently cured to enable passage of pedestrians walking over the substrate within six hours of initial application of the first layer to the substrate, and whereby the multi-layered structure does not experience any detrimental change by the passage of the pedestrians over the substrate. In other embodiments, the substrate is selected to be a horizontal concrete surface and the top layer is sufficiently cured to enable passage of pedestrians walking over the substrate within three hours of initial application of the first layer to the substrate, and whereby the multi-layered structure does not experience any detrimental change by the passage of the pedestrians over the substrate.

Compositions suitable for providing a first layer 5 and optional third layer 9 material according to this disclosure can be colorless or can have coloration imparted to them by adding various tints, dyes and colorants as is generally known in the art. For this purpose any of the TintShot™ product materials available from Citadel are suitably employed.

Consideration must be given to the fact that although this disclosure has been described and disclosed in relation to certain preferred embodiments, obvious equivalent modifications and alterations thereof will become apparent to one of ordinary skill in this art upon reading and understanding this specification and the claims appended hereto. This includes subject matter defined by any combination of any one of the various claims appended hereto with any one or more of the remaining claims, including the incorporation of the features and/or limitations of any dependent claim, singly or in combination with features and/or limitations of any one or more of the other dependent claims, with features and/or limitations of any one or more of the independent claims, with the remaining dependent claims in their original text being read and applied to any independent claims so modified. This also includes combination of the features and/or limitations of one or more of the independent claims with features and/or limitations of another independent claims to arrive at a modified independent claim, with the remaining dependent claims in their original text being read and applied to any independent claim so modified.

I claim:

1) A layered structure which comprises:
a) a substrate;
b) a first layer disposed over said substrate, said first layer comprising a polyurea polymer coating;
c) an optional second layer of material disposed over said first layer, said second layer of material comprising a plurality of solid particles; and
d) an optional third layer disposed over said second layer of material, said third layer comprising a polyurea polymer coating,
said layered substrate being cured sufficiently at the passage of 4 hours from the time of the application of said first layer to said substrate, to enable a motorized vehicle to travel over said layered structure without the layered structure undergoing any detrimental change.

2) A layered structure according to claim 1 wherein said substrate is selected from the group consisting of: cement, concrete, asphalt, steel, and wood.

3) A layered structure according to claim 1 wherein said first layer has an average thickness of any value in the range of between 0.8 mils and 15 mils.

4) A layered structure according to claim 1 wherein said optional third layer, when selected to be present, has an average thickness of any value in the range of between 1 mil and 15 mils.

5) A layered structure according to claim 1 wherein said layer of broadcast material comprises a material selected from the group consisting of: sand, crushed glass, calcium carbonate, stone, crushed stone, gravel, quartz, flints, cherts, and corundum.

6) A layered structure according to claim 1 wherein said optional third layer, when selected to be present, is comprised of the same polyurea polymer as is said first layer.

7) A layered structure according to claim 1 wherein said optional third layer, when selected to be present, is comprised of a polyurea polymer that is physically different than that of which said first layer is comprised.

8) A method of producing a layered structure comprising the steps of:
a) providing a substrate;
b) applying a first layer of flowable material to said substrate, said flowable material comprising polyurea polymer precursors that cure to form a solid polyurea coating;
c) subsequently optionally broadcasting a second layer of a second material upon said first layer, said second material comprising an excessive amount of a plurality of solid particles beyond the amount which is capable of completely adhering to said first layer prior to the cure of said first layer;
d) removing any excess amount of said plurality of solid particles from said layer of a second material.

9) A method according to claim 8 wherein said first layer is cured sufficiently that the resulting layered structure is capable of being walked upon by normal pedestrian traffic without the structure undergoing any detrimental change at the passage of 2 hours from the time of the application of said first layer.

10) A method according to claim 8 wherein said first layer is cured sufficiently that the resulting layered structure is capable of being walked upon by normal pedestrian traffic without the structure undergoing any detrimental change at the passage of 4 hours from the time of the application of said first layer.

11) A method according to claim 8 wherein said first layer is cured sufficiently that the resulting layered structure is capable of being driven on by a motorized vehicle without the structure undergoing any detrimental change at the passage of 2 hours from the time of the application of said first layer.

12) A method according to claim 8 wherein said first layer is cured sufficiently that the resulting layered structure is capable of being driven on by a motorized vehicle without the structure undergoing any detrimental change at the passage of 4 hours from the time of the application of said first layer.

13) A method according to claim 10 further comprising the step of:
e) applying a third layer of flowable material upon said second layer, said third layer of flowable material comprising polyurea polymer precursors that cure to form a solid polyurea coating.

14) A method according to claim 13 wherein said third layer is cured sufficiently that the resulting layered structure is capable of being walked upon by normal pedestrian traffic without the structure undergoing any detrimental change at the passage of 2 hours from the time of the application of said third layer.

15) A method according to claim 13 wherein said third layer is cured sufficiently that the resulting layered structure is capable of being walked upon by normal pedestrian traffic without the structure undergoing any detrimental change at the passage of 4 hours from the time of the application of said first layer.

16) A method according to claim 13 wherein said third layer is cured sufficiently that the resulting layered structure is capable of being driven on by a motorized vehicle without the structure undergoing any detrimental change at the passage of 2 hours from the time of the application of said third layer.

17) A method according to claim 13 wherein said third layer is cured sufficiently that the resulting layered structure is capable of being driven on by a motorized vehicle without the structure undergoing any detrimental change at the passage of 4 hours from the time of the application of said first layer.

18) A layered structure which comprises:
a) a substrate;
b) a layer disposed over said substrate, said layer comprising a polyurea polymer coating,
said layered substrate being cured sufficiently at the passage of 2 hours from the time of the application of said layer to said substrate, to enable a motorized vehicle to travel over said layered structure without the layered structure undergoing any detrimental change.

19) A layered structure according to claim 18 wherein said polyurea polymer coating comprises a single component aromatic polyurea coating.

20) A layered structure according to claim 18 wherein said polyurea polymer coating comprises a two-component aliphatic polyurea coating.
